(19) United States
(12) Patent Application Publication
(10) Pub. No.: US 2008/0151707 A1
(43) Pub. Date: Jun. 26, 2008

(54) OPTICAL DISK DEVICE AND CONTROL METHOD OF OPTICAL DISK DEVICE

(75) Inventor: Masaki Matsumoto, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Osaka (JP)

(21) Appl. No.: 11/955,172

(22) Filed: Dec. 12, 2007

(30) Foreign Application Priority Data
Dec. 21, 2006 (JP) 2006-344591

(51) Int. Cl. G11B 7/00

(52) U.S. Cl. 369/44.22

(57) ABSTRACT

An optical disk device includes an objective lens, a light detector, a lens holder, a focus drive actuator, a servo control section, and a control section. The focus drive actuator drives the lens holder along an optical axis of the objective lens. The servo control section and the control section control the focus drive actuator in such a manner that the objective lens is once separated from the optical disk and then brought close to the optical disk, and that when light reflected from the optical disk is detected by the light detector, the objective lens is brought close to the optical disk at a speed lower than a speed before the light is detected by the light detector. Further, the control section discriminates the kind of the optical disk.

### BACKGROUND OF THE INVENTION

1. Field of the Invention

The present invention relates to an optical disk device, and more particularly to an optical disk device capable of sensing the kind of an optical disk on the basis of a feature to enable the optical disk to be identified.

2. Description of the Background Art

Japanese Patent Laying-Open No. 08-249801 discloses a discrimination method for discriminating a plurality of reflection type optical disks having different thickness corresponding to the kind of the optical disks. The discrimination method is a method available in an optical disk player which reads recorded information from a reflection type optical disk on the basis of a reflected beam obtained from a reflection surface of the reflection type optical disk. The discrimination method includes a measurement process and a discrimination process. In the measurement process, the optical disk player moves an objective lens in the focusing direction on the side of the reflection surface of the reflection type optical disk, and detects a real moving amount of the objective lens during an interval between time points when a peak of the intensity of the reflected beam is generated. In the discrimination process, the optical disk player discriminates the kind of the reflection type optical disk on the basis of the real moving amount.

The invention disclosed in the above described patent document makes it possible to discriminate different kinds of reflection type light disks even having the same diameter.

Japanese Patent Laying-Open No. 2000-260109 discloses a disk discrimination method for discriminating the kind of an optical disk at the time of recording or reproducing data by irradiating a laser beam on the optical disk from a pickup. The disk discrimination method includes a moving step, a measuring step, and a discriminating step. In the moving step, the pickup is moved in the direction perpendicular to the optical disk, while irradiating the laser beam to the optical disk. In the measuring step, a reflected signal indicating that the laser beam is focused on the surface of the optical disk, and first and second peak signals which appear when the laser beam is focused on the pit surface of the optical disk, are measured. In the discriminating step, a first time period between the reflected signal and the first peak signal, and a second time period between the first and second peak signals are obtained, and the ratio of these time periods is calculated, so that the kind of the optical disk is discriminated on the basis of the calculation result of the ratio.

The invention disclosed in the above described patent document makes it possible to discriminate the kind of an optical disk without depending upon the sensitivity of an actuator, and a control voltage and current.

However, the invention disclosed in the above described patent documents has a problem that the kind of an optical disk cannot be accurately discriminated. This phenomenon is often caused when the kind of an optical disk is made to be quickly discriminated.

### SUMMARY OF THE INVENTION

The present invention has been made in order to solve the above described problem. An object of the present invention is to provide an optical disk device capable of accurately discriminating the kind of an optical disk even when the kind of the optical disk is made to be quickly discriminated.

The optical disk device according to the present invention includes: an objective lens for condensing a laser beam on a data recording surface of an optical disk; a detecting section for detecting light reflected from the optical disk; a lens holder for holding the objective lens; a focus drive actuator for driving the lens holder along an optical axis of the objective lens in a manner that the size of force received by the lens holder corresponds to a position of the lens holder; and a control section for controlling the focus drive actuator and discriminating the kind of the optical disk. The control section includes: an access control section for controlling the focus drive actuator in a manner that the objective lens is once separated from the optical disk and then brought close to the optical disk, and that when light reflected from the optical disk is detected by the detecting section, the objective lens is brought close to the optical disk at a speed lower than a speed before the reflected light is detected by the detecting section; a measuring section for measuring a period of time elapsed from the time when the light is detected by the detecting section; and a discriminating section for, when the light is again detected by the detecting section after the start of the time measurement by the measuring section, discriminating the kind of the optical disk on the basis of a period of time measured by the measuring section from the start of the time measurement to the time when the light is again detected by the detecting section.

Preferably, the focus drive actuator has a coil, a magnet, and a member for limiting the moving direction of the lens holder. The access control section includes a focus drive section for supplying the coil with electric power of a current value corresponding to an input control signal, and a signal generating section for generating the control signal in a manner that the objective lens is once separated from the optical disk and then brought close to the optical disk, and that when the light is detected by the detecting section, the objective lens is brought close to the optical disk at a lower speed.

Particularly, the access control section further includes a storage section for storing speed information representing two kinds of speeds different from each other. The signal generating section generates a control signal on the basis of the speed information in a manner that the objective lens is brought close to the optical disk at the higher speed of the two kinds of speeds during a period before the light is detected by the detecting section, and that when the light is detected by the detecting section, the objective lens is brought close to the optical disk at the lower speed of the two kinds of speeds.

A control method of an optical disk device according to the present invention includes the steps of: emitting a laser beam to the optical disk; detecting light reflected from the optical disk; and controlling a position of an objective lens. The step of controlling the position of the objective lens performs control in a manner that the objective lens is once separated from the optical disk and then brought close to the optical disk, and that when light reflected from the optical disk is detected, the objective lens is brought close to the optical disk at a speed lower than a speed before the light is detected, and further includes the steps of: measuring a period of time elapsed from the time when the light is detected; and when the light is again detected after the start of the time measurement, discriminating the kind of the optical disk on the basis the period of time measured from the start of the time measurement to the time when the light is again detected.

The optical disk device according to the present invention is capable of discriminating the kind of an optical disk, even when the kind of the optical disk is made to be quickly discriminated.

The foregoing and other objects, features, aspects and advantages of the present invention will become more apparent from the following detailed description of the present invention, when taken in conjunction with the accompanying drawings.

### BRIEF DESCRIPTION OF THE DRAWINGS

FIG. 1 is a schematic block diagram of an optical disk device according to an embodiment of the present invention;

FIG. 2 is a control block diagram of a computer hardware to realize a control section according to the embodiment of the present invention;

FIG. 3 is a flow chart representing a control procedure of optical disk discrimination processing according to the embodiment of the present invention;

FIG. 4 is a first figure showing an applied magnetic force waveform, a lens displacement waveform, and a detected waveform of reflected light, which are generated in the optical disk device according to the embodiment of the present invention;

FIG. 5 is a second figure showing an applied magnetic force waveform, a lens displacement waveform, and a detected waveform of reflected light, which are generated in the optical disk device according to the embodiment of the present invention;

FIG. 6 is a first figure showing an applied magnetic force waveform, a lens displacement waveform, and a detected waveform of reflected light, which are generated in a optical disk device generally used; and

FIG. 7 is a second figure showing an applied magnetic force waveform, a lens displacement waveform, and a detected waveform of reflected light, which are generated in a optical disk device generally used.

### DESCRIPTION OF THE PREFERRED EMBODIMENTS

In the following, embodiments according to the present invention will be described with reference to the accompanying drawings. In the following description, the same parts are denoted by the same reference numerals. The names and functions of these parts are also the same. Therefore, the detailed description thereof is not repeated.

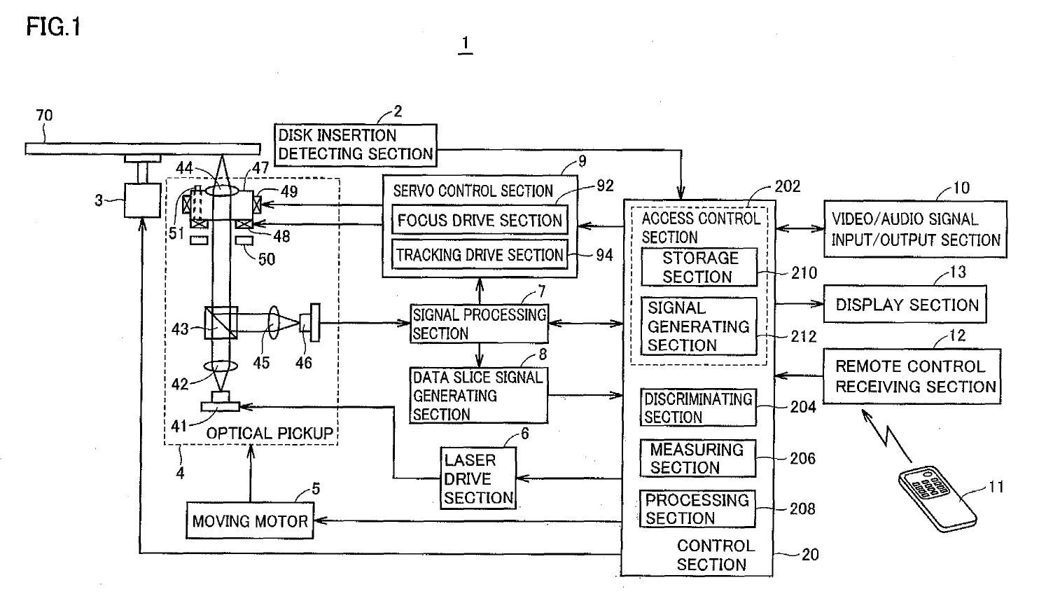

Referring to FIG. 1, an optical disk device 1 according to an embodiment of the present invention performs recording and reproduction of information, such as music and video, to and from an optical disk 70, such as CD (Compact Disc) and DVD (Digital Versatile Disk), on which concentric or spiral information storage trucks are formed.

Optical disk device 1 includes a disk insertion detecting section 2, a spindle motor 3, an optical pickup 4, a moving motor 5, a laser drive section 6, a signal processing section 7, a data slice signal generating section 8, and a servo control section 9. Further, optical disk device 1 includes a video/audio signal input/output section 10, a remote controller 11, a remote control receiving section 12, a display section 13, and a control section 20 for controlling each of the above described sections.

Note that optical pickup 4, signal processing section 7, data slice signal generating section 8, and servo control section 9 constitute an information reading block.

Disk insertion detecting section 2 detects that optical disk 70 is inserted from a disk insertion section (not shown), and inputs the detected signal into control section 20. Inserted optical disk 70 is mounted on spindle motor 3. Spindle motor 3 is rotatably driven according to an instruction of control section 20 so that optical disk 70 is controlled to be rotated at a predetermined speed.

Optical pickup 4 irradiates a light beam for performing recording and reproduction of information to optical disk 70. Also, optical pickup 4 receives reflected light from optical disk 70 and outputs an electric signal by converting the received light to the electric signal. Optical pickup 4 is moved in the radial direction above optical disk 70 by moving motor 5 consisting of a linear motor, on the basis of an instruction from control section 20.

Optical pickup 4 condenses and irradiates a light beam emitted from a semiconductor laser 41 on optical disk 70 via a collimator lens 42, a beam splitter 43, and an objective lens 44. Further, the reflected light from optical disk 70 is received by a light detector 46 via objective lens 44, beam splitter 43, and a condenser lens 45.

The light emission of semiconductor laser 41 is controlled by laser drive section 6 operated in response to the instruction from control section 20. Light detector 46 is constituted by a split photodiode which has a light receiving surface divided into a plurality of regions, and outputs an electric signal according to intensity of light received by each of the divided light receiving surfaces. The output signal from light detector 46 is input into signal processing section 7.

Objective lens 44 is held by a lens holder 47 which is provided with a focusing coil 48 and a tracking coil 49. Focusing coil 48 moves objective lens 44 in the direction perpendicular to the disc surface of optical disk 70 by a magnetic action of a permanent magnet 50. A hole is provided in lens holder 47. A limiting shaft 51 fixed to a base member (not shown) together with permanent magnet 50 penetrates the hole. Limiting shaft 51 limits the moving direction of lens holder 47, so that objective lens 44 is moved in the direction perpendicular to optical disk 70. Focusing coil 48, permanent magnet 50, and limiting shaft 51 constitute a focus drive actuator which drives the lens holder along the optical axis of the objective lens. Further, tracking coil 49 similarly moves objective lens 44 in the direction parallel to the disk surface of optical disk 70, and in the direction perpendicular to the recording track of optical disk 70.

Signal processing section 7 generates an RF signal on the basis of the output signal from light detector 46, and outputs the RF signal to data slice signal generating section 8. Data slice signal generating section 8 generates a data slice signal by binarizing the RF signal, and inputs the data slice signal into control section 20. Control section 20 detects the pits formed in optical disk 70 on the basis of the data slice signal.

Further, signal processing section 7 generates a focus error signal and a track error signal on the basis of the output signal from light detector 46, and outputs the generated signals to servo control section 9. The focus error signal is a signal corresponding to a deviation amount of the condensing point of the light beam irradiated to optical disk 70 via objective lens 44, from the surface of optical disk 70. The track error signal is a signal corresponding to a deviation amount of the condensing point from a recording track.

Servo control section 9 moves objective lens 44 by controlling the supply of current to focusing coil 48 and tracking coil 49 on the basis of the focus error signal and the track error signal. Thereby, the condensing point is servo-controlled so as to be positioned on the surface of optical disk 70 and on the recording track.

Video/audio signal input/output section 10, to which external devices, such as a display, a loudspeaker, a television set (all not shown) are connected, outputs a video signal and an audio signal which are reproduced from optical disk 70, and receives a video signal and an audio signal from the external devices.

Remote controller 11 is to operate various operations of optical disk device 1, and is provided with operation keys (all not shown) for operating the various kinds of operations. Remote controller 11 sends out a corresponding signal in the form of an infrared signal according to the operations of the operation keys. Remote control receiving section 12 receives the infrared signal sent out from remote controller 11, and outputs the received signal to control section 20. Display section 13 is provided in the front panel of optical disk device 1 main body, and displays the contents of operation performed by remote controller 11, the operating state of optical disk device 1, and the like.

Here, the recording and reproduction of information to and from optical disk 70 are described. First, the reproduction of information from optical disk 70 is performed in such a manner that while optical disk 70 is rotated by spindle motor 3 at a predetermined speed, a light beam is irradiated from semiconductor laser 41 to optical disk 70, and the reflected light from optical disk 70 is received by light detector 46. Then, the current supply to focusing coil 48 is controlled to move objective lens 44 by servo control section 9 on the basis of the focus error signal from signal processing section 7, so that the focus-on (focus pull-in) state is effected to make the condensing point of the light from semiconductor laser 41 positioned on the surface of optical disk 70. Further, the current supply to tracking coil 49 is controlled to move objective lens 44 by servo control section 9 on the basis of the track error signal from signal processing section 7, so that the track-on (track pull-in) state is effected to make the condensing point of the light from semiconductor laser 41 positioned on a desired recording track.

After the focus-on state and the track-on state are effected, servo control section 9 controls the current supply to focusing coil 48 and tracking coil 49 on the basis of the focus error signal and the track error signal, and thereby performs the focusing servo control and the tracking servo control so as to maintain the focus-on state and the track-on state.

Then, in this servo state, the RF signal output from signal processing section 7 is input into data slice signal generating section 8. Data slice signal generating section 8 binarizes the RF signal. The data slice signal as a binarized signal is input into control section 20. Control section 20 reads information recorded on optical disk 70 by detecting the presence or absence of the pit formed in optical disk 70 on the basis of the data slice signal, so as to reproduce the read information into a video signal and an audio signal, and outputs the reproduced signal to the external device from video/audio signal input/output section 10.

Further, the recording of information on optical disk 70 is performed similarly in the focusing and tracking servo states by forming pits in optical disk 70 by the light beam emitted from semiconductor laser 41. At this time, a video signal and an audio signal input from video/audio signal input/output section 10 are encoded by control section 20, and the emission of semiconductor laser 41 is controlled under the control of control section 20 according to the encoded data. Thereby, the pits are formed in the recording track of optical disk 70 in correspondence with the encoded data, so that the video and audio information is recorded. When the pits are formed, semiconductor laser 41 is made to emit light at an output power higher than the power at the time of reading information, to thereby enable the pits to be formed.

Optical disk device 1 constituted as described above performs reproduction of the information from optical disk 70, recording of the information on optical disk 70 and the like, under the control of control section 20 according to the operation by remote controller 11. Further, when optical disk 70 is inserted, optical disk device 1 performs an initial operation for reading information recorded on the innermost peripheral side of optical disk 70, under the control of control section 20. Then, optical disk device 1 determines the kind and recorded contents of inserted optical disk 70 on the basis of the information read by the initial operation, and controls the subsequent operations such as recording and reproduction of information.

Servo control section 9 includes a focus drive section 92 and a tracking drive section 94. Focus drive section 92 supplies focusing coil 48 with electric power of a current value corresponding to an input control signal. Focusing coil 48 supplied with the electric power generates a magnetic force. This magnetic force moves objective lens 44 in the direction perpendicular to the disk surface of optical disk 70. Tracking drive section 94 supplies tracking coil 49 with electric power of a current value corresponding to an input control signal. Tracking coil 49 supplied with the electric power also generates a magnetic force. This magnetic force moves objective lens 44 in the direction parallel to the disk surface of optical disk 70, and in the direction perpendicular to the recording track of optical disk 70.

Control section 20 includes an access control section 202, a discriminating section 204, a measuring section 206, and a processing section 208. Access control section 202 controls the focus drive actuator in such a manner that the objective lens is once separated from the optical disk, and is then again brought close to the optical disk, and that when light reflected from the optical disk is detected by light detector 46, the objective lens is brought close to the optical disk at a speed lower than a speed before the time when the light is detected by light detector 46. Discriminating section 204 discriminates the kind of optical disk 70 on the basis of a period of time measured by measuring section 206. Measuring section 206 measures the period of time according to the control of access control section 202 or processing section 208. Processing section 208 creates a video signal and an audio signal to be output to video/audio signal input/output section 10 and the like, on the basis of the signal received from signal processing section 7 and the like.

Access control section 202 includes a storage section 210 and a signal generating section 212. Storage section 210 stores speed information representing two kinds of speeds different from each other. Signal generating section 212 generates a control signal on the basis of the speed information. The control signal generated in the period before the time when the reflected light is detected by light detector 46, is a control signal for bringing objective lens 44 close to optical disk 70 at the higher speed among the two kinds of speeds represented by the speed information. The control signal generated in the period after the time when the reflected light is detected by light detector 46, is a control signal for bringing objective lens 44 close to optical disk 70 at the lower speed among the two kinds of speeds represented by the speed information.

It is desirable that the two kinds of speeds represented by the speed information is determined by an experiment. As will be described below, lens holder 47 is brought close to optical disk 70 at the higher speed among the two kinds of speeds, and when the reflected light is detected by light detector 46, lens holder 47 is brought close to optical disk 70 at the lower speed among the two kinds of speeds. In this case, when the speed before the time when the reflected light is detected by light detector 46 is too high, even if lens holder 47 is consistently controlled to be brought close to optical disk 70, lens holder 47 is brought close to and away from optical disk 70. When the difference in the speeds before and after the time when the reflected light is detected by light detector 46 is too large, the same phenomenon is caused. In this case, the frequency at which lens holder 47 is brought close to and away from optical disk 70 becomes a certain fixed frequency.

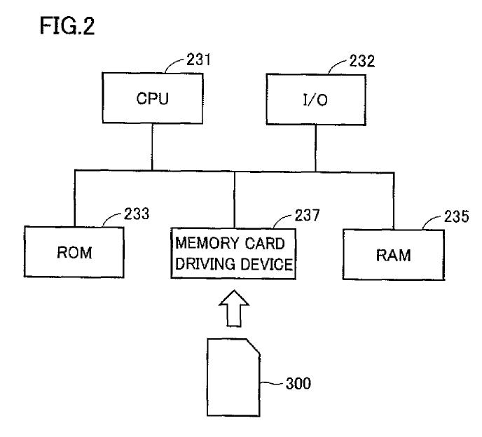

Referring to FIG. 2, control section 20 according to the present embodiment includes a CPU (Central Processing Unit) 231, an I/O (Input/Output) 232, a ROM (Read Only Memory) 233, a RAM (Random Access Memory) 235, a memory card driving device 237, and a bus 239. CPU 231 performs an arithmetic operation necessary for the computer hardware shown in FIG. 2 to operate as control section 20. I/O 232 relays signals between the respective sections constituting optical disk device 1. ROM 233 stores a program which CPU 231 executes. RAM 235 temporarily stores data which CPU 231 utilizes. Memory card driving device 237 reads a program and other data from a memory card 300. Bus 239 transmits signals between the respective sections constituting control section 20.

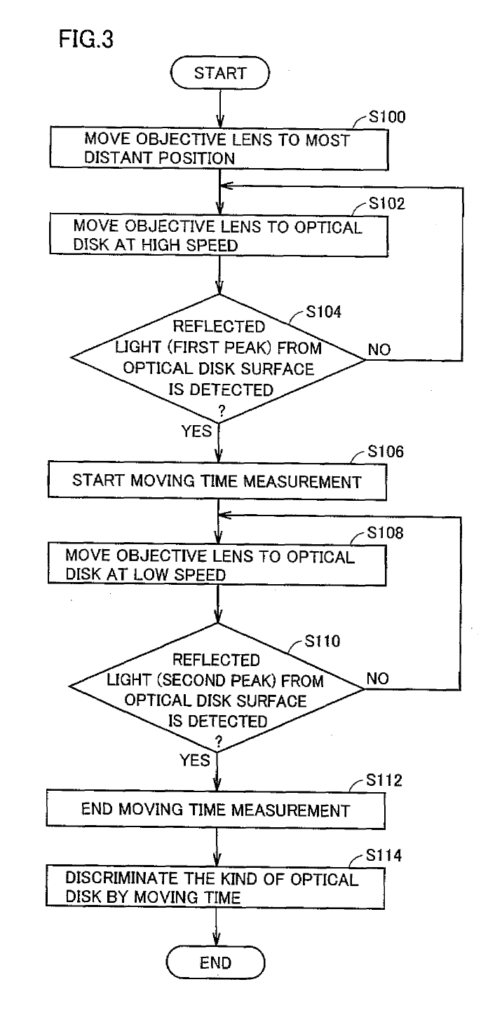

Referring to FIG. 3, the program executed by control section 20 executes the following control on the discrimination of optical disk 70.

In step S100, signal generating section 212 generates a control signal for moving objective lens 44 to a position most distant from the disk surface of optical disk 70 on the basis of the speed information stored in storage section 210. This signal is output to servo control section 9. Focus drive section 92 supplies focusing coil 48 with electric power of a current value corresponding to the input control signal. Focusing coil 48 supplied with the electric power generates a magnetic force. The magnetic force generated by focusing coil 48 moves objective lens 44 to a position most distant from the disk surface of optical disk 70. The speed at which objective lens 44 is moved is the higher speed among the two kinds of speeds represented by the speed information stored in storage section 210.

In step S102, signal generating section 212 generates a control signal for bringing objective lens 44 close to optical disk 70 on the basis of the speed information stored in storage section 210. This signal is output to servo control section 9. Focus drive section 92 supplies focusing coil 48 with electric power of a current value corresponding to the input control signal. Focusing coil 48 supplied with the electric power generates a magnetic force. The magnetic force generated by focusing coil 48 brings objective lens 44 close to the disk surface of optical disk 70. The speed at which objective lens 44 is moved is the higher speed among the two kinds of speeds represented by the speed information stored in storage section 210.

In step S104, signal generating section 212 determines whether or not reflected light reflected from optical disk 70 is detected by light detector 46. When signal generating section 212 determines that the reflected light is detected by light detector 46 (YES in step S104), the process shifts to step S106. Otherwise (NO in step S104), the process shifts to step S102.

In step S106, signal generating section 212 outputs a control signal for enabling measuring section 206 to start measurement of time. When the control signal is output, measuring section 206 starts the measurement of time.

In step S108, signal generating section 212 generates a control signal for bringing objective lens 44 close to optical disk 70 on the basis of the speed information stored in storage section 210. This signal is output to servo control section 9. Focus drive section 92 supplies focusing coil 48 with electric power of a current value corresponding to the input control signal. The magnetic force generated by focusing coil 48 brings objective lens 44 close to the disk surface of optical disk 70. The current value of the electric power supplied to focusing coil 48 is smaller than the current value of the electric power in step S102. This makes the magnetic force generated by focusing coil 48 smaller than the magnetic force in step S102. Since the magnetic force is reduced, the speed at which objective lens 44 is brought close to the disk surface of optical disk 70 is made lower than the speed of objective lens 44 in step S102. This speed is the lower speed of the two kinds of speeds represented by the speed information stored in storage section 210.

In step S110, signal generating section 212 determines whether or not the reflected light reflected from optical disk 70 is again detected by light detector 46. When signal generating section 212 determines that the reflected light is again detected by light detector 46 (YES in step S110), the process shifts to step S112. Otherwise (NO in step S110), the process shifts to step S108.

In step S110, signal generating section 212 outputs a control signal for terminating the measurement of time to measuring section 206. When this control signal is output, measuring section 206 terminates the measurement of time. Also, measuring section 206 outputs the measured period of time to discriminating section 204.

In step S114, discriminating section 204 discriminates the kind of the optical disk on the basis of the period of time measured by measuring section 206 during the period from step S106 to step S112. This period of time represent a period of time, during which objective lens 44 is continuously moved from the time when the reflected light reflected from optical disk 70 is first detected by light detector 46 to the time when the reflected light reflected from optical disk 70 is again detected by light detector 46. This period of time is different according to the kind of optical disk 70. This is because the position of a layer capable of reflecting the light is different for each kind of optical disk 70. For this reason, it is possible for discriminating section 204 to discriminate the kind of optical disk 70 on the basis of this period of time. The specific method for discriminating section 204 to discriminate the kind of optical disk 70 is not limited in particular, but may, for example, be a method for storage section 210 to store a database representing a relation between the period of time and the kind of optical disk 70. In this case, it is possible for discriminating section 204 to discriminate the kind of optical disk 70 by reading from the database the information on the kind of optical disk 70, which information corresponds to the period of time measured by measuring section 206 during the period from step S106 to step S112.

An operation of optical disk device 1 based on the above described constitution and flow chart will be described.

Signal generating section 212 moves objective lens 44 to a position most distant from the disk surface of optical disk 70 by generating a control signal (step S100). The speed at which objective lens 44 is moved is the higher speed among the two kinds of speeds represented by the speed information stored in storage section 210.

When objective lens 44 is moved to the position most distant from the disk surface of optical disk 70, signal generating section 212 brings objective lens 44 close to optical disk 70 by generating a control signal (step S102). The speed at which objective lens 44 is moved is the higher speed among the two kinds of speeds represented by the speed information stored in storage section 210.

When objective lens 44 begins to be brought close to optical disk 70, signal generating section 212 determines whether or not the reflected light reflected from optical disk 70 is detected by light detector 46 (step S104). At the beginning, such reflected light is not detected by light detector 46 (NO in step S104), and hence the processing in step S102 is again repeated. Thereafter, the processing in step S102 and the processing in step S104 are repeated for the time being.

While the processing in step S102 and the processing in step S104 are repeated, objective lens 44 is brought closer to optical disk 70. As a result, the reflected light reflected from optical disk 70 is detected by light detector 46 at a certain time point. This makes signal generating section 212 determine that the reflected light is detected by light detector 46 (YES in step S104). Thereby, signal generating section 212 outputs a control signal to measuring section 206 to make it start measurement of time (step S106).

When the control signal is output to measuring section 206, signal generating section 212 brings objective lens 44 close to optical disk 70 by generating a control signal (step S108). The speed at which objective lens 44 is moved is the lower speed among the two kinds of speeds represented by the speed information stored in storage section 210.

When the speed at which objective lens 44 is brought close to optical disk 70 is lowered, signal generating section 212 determines whether or not the reflected light reflected from optical disk 70 is again detected by light detector 46 (step S110). At the beginning, such reflected light is not detected by light detector 46 (NO in step S110), and hence the processing in step S108 is again repeated. Thereafter, the processing in step S108 and the processing in step S110 are repeated for the time being.

While the processing in step S108 and the processing in step S110 are repeated, objective lens 44 is brought closer to optical disk 70. As a result the reflected light reflected from optical disk 70 is detected by light detector 46 at a certain time point. This makes signal generating section 212 determine that the reflected light is detected by light detector 46 (YES in step S110). Thus, signal generating section 212 outputs a control signal to measuring section 206 to make it end the measurement of time. When the control signal is output to measuring section 206, measuring section 206 ends the measurement of time. Also, measuring section 206 outputs the measured period of time to discriminating section 204 (step S112).

When the measured period of time is output to discriminating section 204, discriminating section 204 discriminates the kind of the optical disk on the basis of the period of time measured by measuring section 206 during the period from step S106 to step S112 (step S114).

As described above, after the reflected light reflected from optical disk 70 is first detected by light detector 46, optical disk device 1 according to the present embodiment lowers the moving speed of objective lens 44. As a result, the possibility that the kind of optical disk 70 is incorrectly discriminated is reduced.

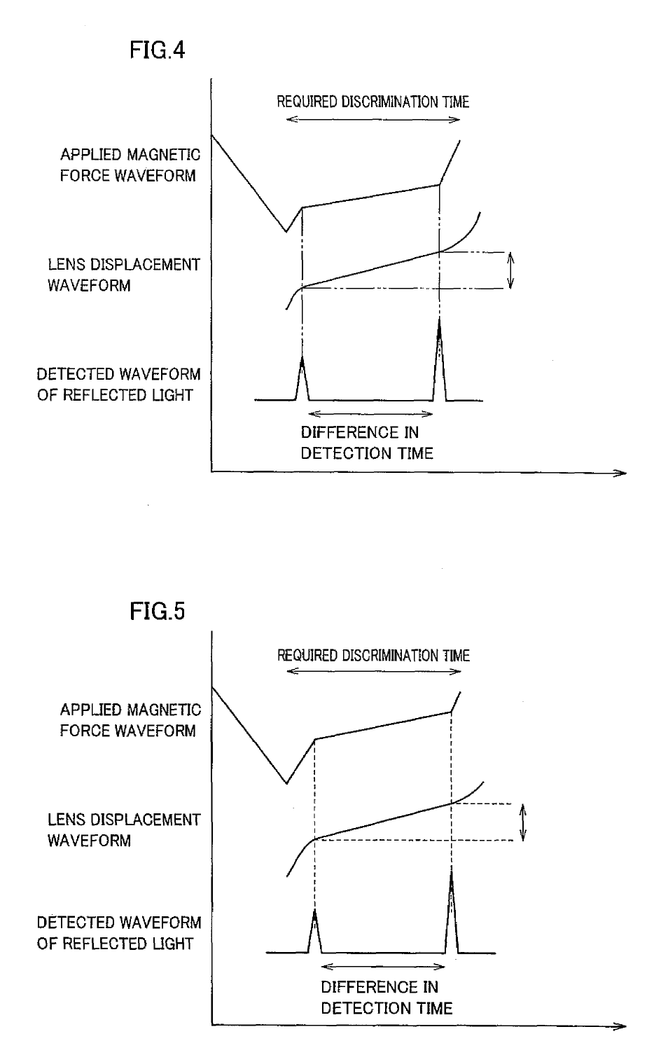

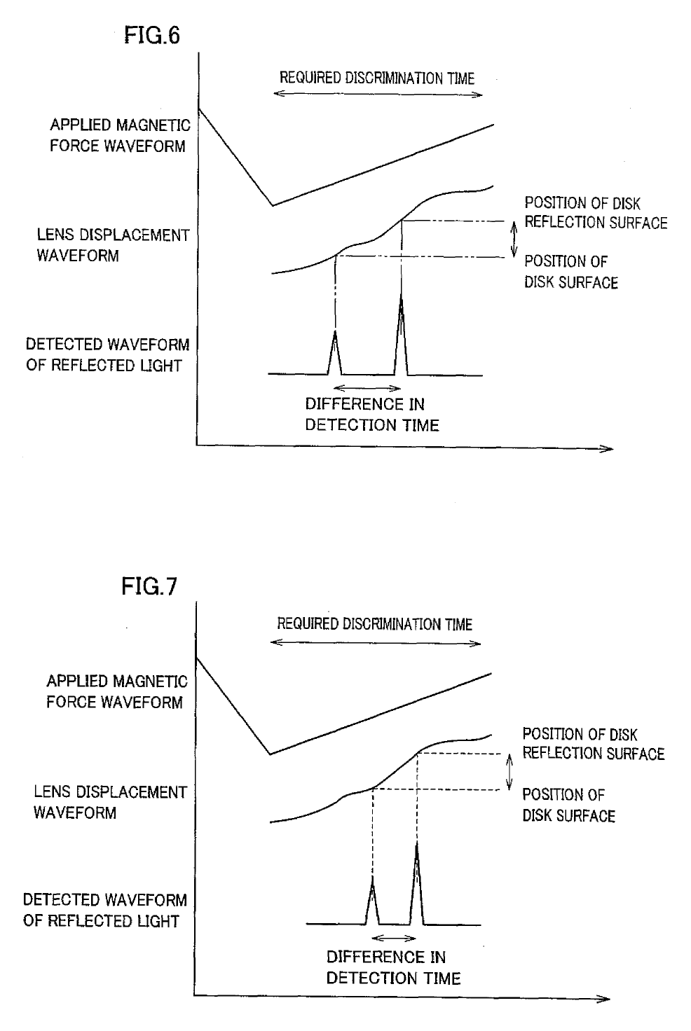

With reference to FIG. 4 and FIG. 5, there are described an applied magnetic force waveform, a lens displacement waveform, and a detected waveform of reflected light, which are generated in optical disk device 1 according to the present embodiment. With reference to FIG. 6 and FIG. 7, there are described an applied magnetic force waveform, a lens displacement waveform, and a detected waveform of reflected light, which are generated in an optical disk device adapted to drive an objective lens by using a focusing coil and a permanent magnet and is generally used. In the present embodiment, “applied magnetic force waveform” represents transition of a magnetic force generated between focusing coil 48 and permanent magnet 50. “Lens displacement waveform” represents transition of a position of objective lens 44. “Detected waveform of reflected light” represents a signal output by light detector 46. When this waveform represents a peak, it is considered that the reflected light from optical disk 70 is detected by light detector 46. In the figure shown in FIG. 4, and the figure shown in FIG. 5, the conditions for detecting the waveforms are the same except for the difference in the time when the waveforms are detected. Also, in the figure shown in FIG. 6, and the figure shown in FIG. 7, the conditions for detecting the waveforms are the same except for the difference in the time when the waveforms are detected.

When FIG. 4 is compared with FIG. 5, it can be seen that the intervals between the time when the detected waveform of reflected light first represents a peak and the time when the detected waveform of reflected light next represents a peak, are the same with each other. This means that the measured value of the interval is stable.

On the other hand, when FIG. 6 is compared with FIG. 7, it can be seen that the intervals between the time when the detected waveform of reflected light first represents a peak and the time when the detected waveform of reflected light next represents a peak, are different from each other.

The peak shapes in the lens displacement waveforms are present at points common between FIG. 4 and FIG. 5, but the peak shapes in the lens displacement waveforms are present at points different between FIG. 6 and FIG. 7. In the case of FIG. 4 and FIG. 5, the lens displacement waveform during a period from the time when the detected waveform of reflected light first represents a peak to the time when the detected waveform of reflected light next represents a peak, represents a straight line. On the other hand, in the case of FIG. 6 and FIG. 7, the lens displacement waveforms during the period are in a wavy state and different in shape from each other.

The fact that the intervals from the time when the detected waveform of reflected light first represents a peak to the time when the detected waveform of reflected light next represents a peak are different from each other between FIG. 6 and FIG. 7, is considered to be caused by the movement of the objective lens as represented by the lens displacement waveform. In the case of an actuator which controls the position of the lens holder by controlling the force applied to the lens holder, when the force received by the lens holder is changed, the position of the lens holder is also changed. In the case of such an actuator, the contents of movement of the objective lens are made different each time the objective lens is driven. The contents of movement of the objective lens are made different each time the objective lens is driven, and hence the interval between the time when the detected waveform first represents a peak and the time when the detected waveform next represents a peak is also made different each time the objective lens is driven.

On the other hand, in optical disk device 1 according to the present embodiment, the moving speed of objective lens 44 is lowered from the time when the detected waveform first represents a peak. When the moving speed is lowered, it is less likely that the movement subsequent to the time when the speed is lowered, causes objective lens 44 to be moved in a manner different from the control content. It is less likely that objective lens 44 is moved in a manner different from the control content, and hence, as shown in FIG. 4 and FIG. 5, the lens displacement waveform represents a straight line during the period from the time when the detected waveform of reflected light first represents a peak to the time when the detected waveform of reflected light next represents a peak. The lens displacement waveform represents the straight line, which reduces the fluctuation in the period of time from the time when the reflected light reflected from optical disk 70 is first detected by light detector 46 to the time when the reflected light reflected from optical disk 70 is next detected by light detector 46. The fluctuation is reduced, and hence the possibility that the kind of optical disk 70 is incorrectly discriminated is reduced.

In addition, until the reflected light reflected from optical disk 70 is first detected, the moving speed of objective lens 44 is high as compared with the speed subsequent to the detection of the reflected light. Since the moving speed until the reflected light is first detected is high, the total of the time periods required to discriminate the kind of optical disk 70 is shortened, as compared with the case where objective lens 44 is brought close to optical disk 70 at a fixed low speed. As a result, it is possible to provide optical disk device 1 which is capable of accurately discriminate the kind of an optical disk, even when the kind of the optical disk is made to be quickly discriminated.

Note that, as a first modification, signal generating section 212 may change the moving speed of objective lens 44 without depending on the speed information stored in storage section 210. An example of the method for changing the moving speed of objective lens 44 without depending on the speed information stored in storage section 210 includes a method in which signal generating section 212 includes a plurality of circuits for generating control signals. In this case, the circuits are constituted in such a manner that the moving speed of objective lens 44 is changed according to a difference between the control signals generated by the circuits.

Further, as a second modification, the focus drive actuator may not be an actuator which drives lens holder 47 by focusing coil 48 and permanent magnet 50, as long as the focus drive actuator is adapted such that the size of force received by lens holder 47 corresponds to the position of lens holder 47.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An optical disk device comprising:
an objective lens for condensing a laser beam on a data recording surface of an optical disk;
a detecting section for detecting light reflected from the optical disk;
a lens holder for holding the objective lens;
a focus drive actuator for driving the lens holder along an optical axis of the objective lens in a manner that the size of force received by the lens holder corresponds to a position of the lens holder; and
a control section for controlling the focus drive actuator and discriminating the kind of the optical disk,
wherein the control section comprises:
an access control section for controlling the focus drive actuator in a manner that the objective lens is once separated from the optical disk and then brought close to the optical disk, and that when light reflected from the optical disk is detected by the detecting section, the objective lens is brought close to the optical disk at a speed lower than a speed before the light is detected by the detecting section;
a measuring section for measuring a period of time elapsed from the time when the light is detected by the detecting section; and
a discriminating section for, when the light is again detected by the detecting section after the start of the time measurement by the measuring section, discriminating the kind of the optical disk on the basis of a period of time measured by the measuring section from the start of the time measurement to the time when the light is again detected by the detecting section.

2. The optical disk device according to claim 1,
wherein the focus drive actuator comprises:
a coil;
a magnet; and
a member for limiting the moving direction of the lens holder, and
wherein the access control section comprises:
a focus drive section for supplying the coil with electric power of a current value corresponding to an input control signal; and
a signal generating section for generating the control signal in a manner that the objective lens is once separated from the optical disk and then brought close to the optical disk, and that when the light is detected by the detecting section, the objective lens is brought close to the optical disk at a lower speed.

3. The optical disk device according to claim 2,
wherein the access control section further comprises a storage section for storing speed information representing two kinds of speeds different from each other, and
wherein the signal generating section generates the control signal on the basis of the speed information in a manner that the objective lens is brought close to the optical disk at the higher speed among the two kinds of speeds during a period until the light is detected by the detecting section, and that when the light is detected by the detecting section, the objective lens is brought close to the optical disk at the lower speed among the two kinds of speeds.

4. A control method of an optical disk device comprising the steps of:
emitting a laser beam to an optical disk;
detecting light reflected from the optical disk; and
controlling a position of an objective lens,
wherein the step of controlling the position of the objective lens performs control in a manner that the objective lens is once separated from the optical disk and then brought close to the optical disk, and that when light reflected from the optical disk is detected, the objective lens is brought close to the optical disk at a speed lower than a speed before the light is detected, and further comprises the steps of:
measuring a period of time elapsed from the time when the light is detected; and
when the light is again detected after the start of the time measurement, discriminating the kind of the optical disk on the basis of a period of time measured until the light is again detected.
